(19) United States
(12) Patent Application Publication
(10) Pub. No.: US 2023/0252593 A1
(43) Pub. Date: Aug. 10, 2023

(54) SUPPORTER INTRODUCTION METHOD

(71) Applicant: TOYOTA JIDOSHA KABUSHIKI KAISHA, Toyota-shi Aichi-ken (JP)

(72) Inventors: Taizo MASUDA, Yokohama-shi Kanagawa-ken (JP); Ryota TOMIZAWA, Mishima-shi Shizuoka-ken (JP); Sei MIYAZAKI, Susono-shi Shizuoka-ken (JP); Yuki NISHIKAWA, Susono-shi Shizuoka-ken (JP)

(73) Assignee: TOYOTA JIDOSHA KABUSHIKI KAISHA, Toyota-shi Aichi-ken (JP)

(21) Appl. No.: 17/980,647

(22) Filed: Nov. 4, 2022

(30) Foreign Application Priority Data
Feb. 7, 2022 (JP) 2022-017136

(51) Int. Cl. G06Q 50/30; G06Q 10/02

(52) U.S. Cl. CPC G06Q 50/30; G06Q 10/02

(57) ABSTRACT

A supporter introduction method includes: an acquisition step of acquiring user information on a user using a vehicle; a determination step of determining whether the user is a handicapped person or not, based on the user information; a specifying step of, in a case where the user is determined to be a handicapped person, specifying a position and a time desired by the user for support based on the user information; and a matching step of matching the user with a supporter who supports the user, based on the position and the time desired by the user for support.

### CROSS-REFERENCE TO RELATED APPLICATION

This application claims priority to Japanese Patent Application No. 2022-017136 filed on Feb. 7, 2022, incorporated herein by reference in its entirety.

### BACKGROUND

### 1. Technical Field

The present disclosure relates to the technical field of a supporter introduction method.

### 2. Description of Related Art

There has been proposed a vehicle allocation service in which the allocation of a vehicle such as a taxi, for example, can be reserved from an application in a terminal device possessed by a user (see Japanese Unexamined Patent Application Publication No. 2021-018694 (JP 2021-018694 A)).

### SUMMARY

handicapped person may also use the above vehicle allocation service as well as a physically unimpaired person. In a case where a handicapped person uses the vehicle allocation service without an attendant such as a protector, for example, it might be difficult for the handicapped person to get in and out of a vehicle.

The present disclosure is accomplished in view of the above problem, and an object of the present disclosure is to provide a supporter introduction method that can introduce a supporter to a handicapped person.

A supporter introduction method according to one aspect of the present disclosure includes: an acquisition step of acquiring user information on a user using a vehicle; a determination step of determining whether the user is a handicapped person or not, based on the user information; a specifying step of, in a case where the user is determined to be a handicapped person, specifying a position and a time desired by the user for support based on the user information; and a matching step of matching the user with a supporter who supports the user, based on the position and the time desired by the user for support.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating the outline of a support system according to a first embodiment;

FIG. 2 is a block diagram illustrating a configuration of a server according to the first embodiment;

FIG. 3 is a flowchart illustrating the operation of the server according to the first embodiment; and

FIG. 4 is a flowchart illustrating the operation of a server according to a second embodiment.

### DETAILED DESCRIPTION OF EMBODIMENTS

The following will describe embodiments of a supporter introduction method with reference to the drawings. The following embodiments deal with, as an example, a supporter introduction method in a boarding reservation system for a route bus. The supporter introduction method is not limited to the route bus and can be also applied to a vehicle allocation system for a taxi, a train reservation system, and so on, for example.

### First Embodiment

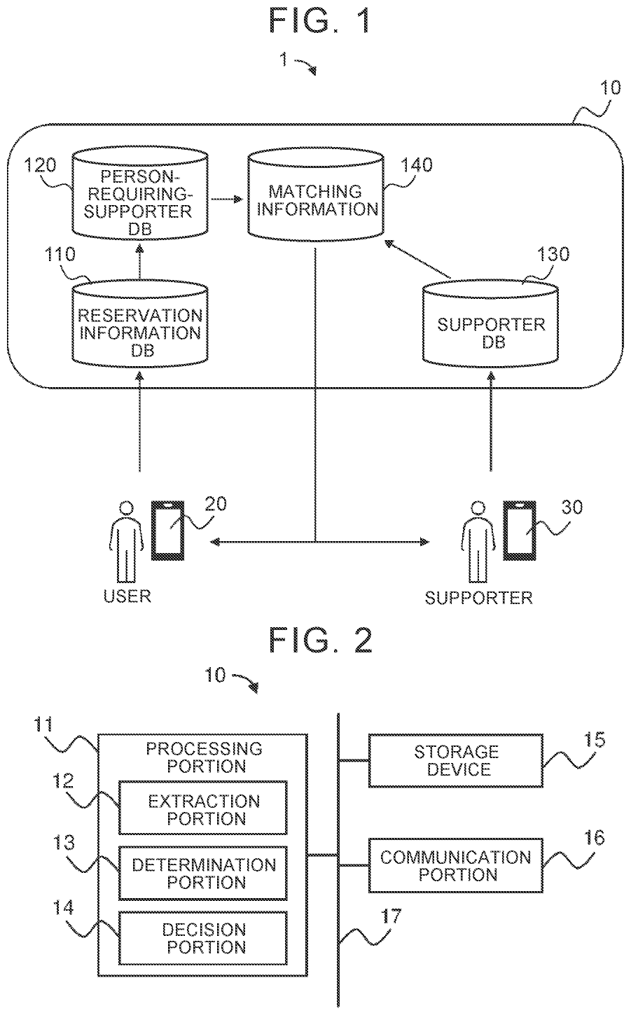

A first embodiment of the supporter introduction method will be described with reference to FIGS. 1 to 3. A “user” indicates a user of a route bus. The user includes a physically unimpaired person and a handicapped person. A “supporter” may be the user of the route bus or may not be the user of the route bus.

In FIG. 1, a support system 1 includes a server 10, a terminal device 20 possessed by the user, and a terminal device 30 possessed by the supporter. An application to use the support system 1 is installed in each of the terminal devices 20, 30. In the server 10, a reservation information database 110 (hereinafter referred to as a “reservation information DB 110”) for a route bus, a person-requiring-support database 120 (hereinafter referred to as a “person-requiring-support DB 120”), a supporter database 130 (hereinafter referred to as a “supporter DB 130”), and matching information 140 are stored.

The reservation information DB 110 includes reservation information input by the user via the terminal device 20. The reservation information includes, for example, vehicle information (e.g., bus number) to specify a route bus that the user takes, a getting-on position (e.g., the name of a stop) and a getting-on scheduled time at which the user gets on the route bus, a getting-off position (e.g., the name of a stop) and a getting-off scheduled time at which the user gets off the route bus, and so on. The reservation information is associated with user information to specify the user. The user information may include, for example, a full name, contact information (a telephone number, e-mail address, address, and the like), sex, age, information indicative of settlement methods, and so on. In the present embodiment, the user information particularly includes information indicative of whether the user is a handicapped person or not.

Note that an identification number may be assigned to the user information. The user information may be stored in a user information database (not illustrated), for example, together with the assigned identification number. In this case, the reservation information may be associated with the identification number assigned to the user information, instead of the user information.

In the support system 1, in a case where the user information includes information indicating that the user is a handicapped person, the user can request (desire) support for the use of the route bus. When the user inputs reservation information, for example, the user may input contents of the support. The contents of the support may be, for example, guidance to a bus stop for the route bus, assistance to get on and off the route bus, guidance from a getting-off place where the user gets off the route bus to a destination, or the like. Support request information indicative of the contents of the support is stored in the reservation information DB 110 in association with the reservation information. Here, the position and the date and time requested by the user for support may be decided based on the reservation information on the user. For example, in a case where the content of the support is guidance to the bus stop for the route bus, the position and the date and time requested for the support may be a getting-on position and a getting-on scheduled time at which the user gets on the route bus, the getting-on position and the getting-on scheduled time being included in the reservation information. For example, in a case where the content of the support is guidance from the getting-off place where the user gets off the route bus to the destination, the position and the date and time requested for the support may be a getting-off position and a getting-off scheduled time at which the user gets off the route bus, the getting-off position and the getting-off scheduled time being included in the reservation information.

The server 10 specifies reservation information associated with user information including information indicating that the user is a handicapped person, from among pieces of reservation information included in the reservation information DB 110. In a case where the specified reservation information is associated with support request information, the server 10 stores the reservation information in the person-requiring-support DB 120 together with the support request information. That is, the server 10 determines whether or not the user who has reserved the route bus is a handicapped person, based on the user information associated with the reservation information. In a case where the server 10 determines that the user is a handicapped person, the server 10 determines whether the reservation information on the user is associated with support request information or not. In a case where the server 10 determines that the reservation information is associated with support request information, the server 10 stores the reservation information in the person-requiring-support DB 120 together with the support request information.

The supporter DB 130 includes supporter information input by the supporter via the terminal device 30. The supporter information may include, for example, information to specify the supporter, support information indicative of contents of support that the supporter can provide, and so on. The information to specify the supporter may include, for example, a full name, contact information (a telephone number, e-mail address, address, and the like), sex, age, qualification information (a care worker, a guide helper, a sign-language interpreter, or the like), and so on. The support information may include, for example, a date and time when and a place where the supporter can provide support, contents of support that the supporter can provide, and so on.

The matching information 140 includes a matching result between support request information associated with reservation information included in the person requiring support DB and supporter information included in the supporter DB 130. Matching between the support request information and the supporter information is performed by the server 10 (details will be described later). The server 10 transmits a result of the matching to the terminal devices 20, 30.

The server 10 will be described with reference to FIG. 2. The server 10 includes a processing portion 11, a storage device 15, and a communication portion 16. The processing portion 11, the storage device 15, and the communication portion 16 are connected to each other via a bus 17. The reservation information DB 110, the person-requiring-support DB 120, the supporter DB 130, and the matching information 140 may be built in the storage device 15. In order to perform the matching, the processing portion 11 includes an extraction portion 12, a determination portion 13, and a decision portion 14 as logical blocks logically implemented or processing circuits physically implemented.

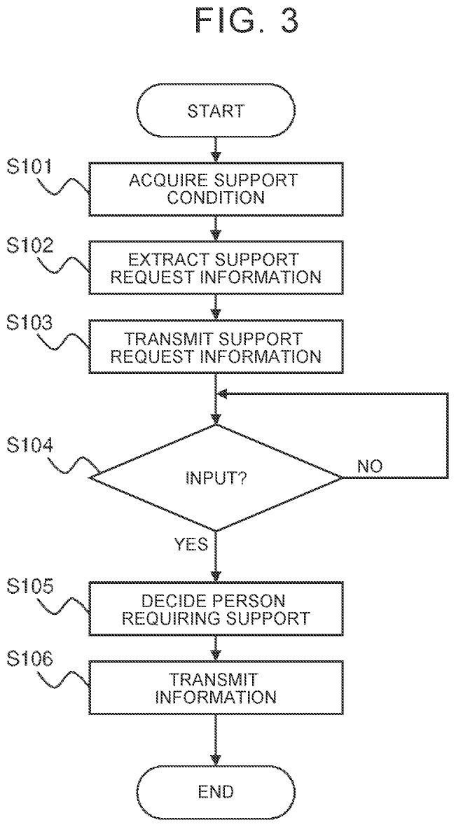

The following describes the operation of the processing portion 11 with reference to the flowchart of FIG. 3 in addition to FIG. 2. In the present embodiment, when the supporter inputs supporter information via the terminal device 30, support request information corresponding to support information included in the supporter information thus input, from among pieces of support request information stored in the person-requiring-support DB 120, is displayed on the terminal device 30.

In FIG. 3, the processing portion 11 acquires a support condition (that is, a condition for support providable by the supporter) from the support information included in the supporter information (step S101). The extraction portion 12 of the processing portion 11 extracts support request information that satisfies the acquired support condition from among the pieces of support request information included in the person-requiring-support DB 120 (step S102). At this time, reservation information and user information associated with support request information may be also extracted.

The processing portion 11 transmits the extracted support request information to the terminal device 30 via the communication portion 16 (step S103). After that, the determination portion 13 of the processing portion 11 determines whether or not there is an input from the supporter via the terminal device 30 (step S104). In the process of step S104, in a case where the determination portion 13 determines that there is no input from the supporter (step S104: No), the process of step S104 is performed. That is, a stand-by state continues until there is an input from the supporter.

In the process of step S104, in a case where the determination portion 13 determines that there is an input from the supporter (step S104: Yes), the decision portion 14 of the processing portion 11 decides a person requiring support based on the input from the supporter (step S105). At this time, the decision portion 14 stores, in the matching information 140, information (that is, reservation information, user information, and support request information) on the decided person requiring support in association with the supporter information. Further, the decision portion 14 deletes the information on the decided person requiring support from the person-requiring-support DB 120.

More specifically, in a case where a plurality of pieces of support request information is extracted in the process of step S102, all the pieces of support request information thus extracted are transmitted to the terminal device 30 in the process of step S103. In this case, in the process of step S105, the decision portion 14 decides, as the person requiring support, a user specified by user information associated with one support request information selected by the supporter from among the pieces of support request information. In a case where one support request information is extracted in the process of step S102, the decision portion 14 decides, as the person requiring support, a user specified by user information associated with the one support request information thus extracted, in the process of step S105.

The processing portion 11 transmits, to the terminal device 30 via the communication portion 16, information for the supporter to specify a person requiring support from the user information on the user corresponding to the person requiring support who is decided in the process of step S105. Further, the processing portion 11 transmits, to the terminal device 20 via the communication portion 16, information for the person requiring support to specify the supporter from the supporter information on the supporter (step S106). The information for the supporter to specify the person requiring support may include, for example, the full name of the person requiring support, contact information, position information indicative of the current location of the person requiring support, information indicative of the feature of the appearance of the person requiring support, and so on. The information for the person requiring support to specify the supporter may include, for example, the full name of the supporter, contact information, position information indicative of the current location of the supporter, information indicative of the feature of the appearance of the supporter, and so on.

Note that, in a case where no support request information is extracted in the process of step S102 (in other words, in a case where there is no support request information that satisfies the support condition acquired from the support information), the processing portion 11 may store the supporter information in the supporter DB 130. In a case where there is no input from the supporter for a predetermined time in the process of step S104, the determination portion 13 of the processing portion 11 may consider that the matching fails and may end the operation illustrated in FIG. 3. In this case, the processing portion 11 may store, in the supporter DB 130, the supporter information for which the matching fails.

Technical Effects

With the support system 1 according to the first embodiment, it is possible to introduce a supporter to a handicapped person who requires support.

### Second Embodiment

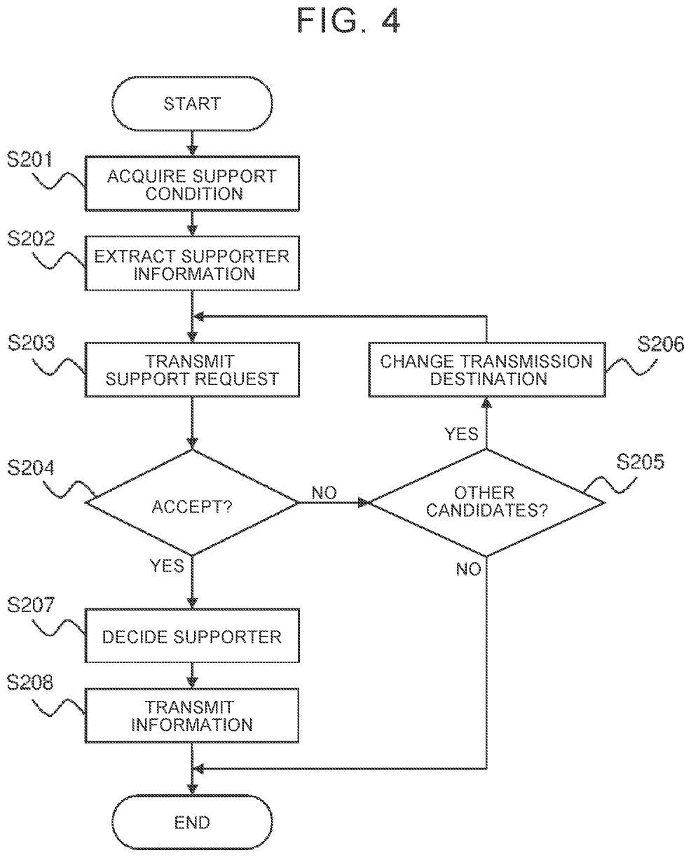

A second embodiment of the supporter introduction method will be described with reference to FIG. 4. The second embodiment is similar to the first embodiment except the operation of the processing portion 11. Accordingly, the second embodiment mainly describes parts different from the first embodiment, and descriptions on parts similar to the first embodiment are omitted appropriately.

In the present embodiment, pieces of supporter information are accumulated in the supporter DB 130, and when a user (that is, a handicapped person) who requires support inputs support request information via the terminal device 20, the processing portion 11 selects supporter information corresponding to the support request information.

In FIG. 4, the processing portion 11 acquires a support condition (that is, a condition for support that the handicapped person requires) from the support request information (step S201). The extraction portion 12 of the processing portion 11 extracts one or more pieces of supporter information including support information that satisfies the acquired support condition from among the pieces of supporter information included in the supporter DB 130 (step S202).

The processing portion 11 transmits a signal indicative of a support request to the terminal device 30 of a supporter specified by supporter information most suitable for the acquired support condition from among the one or more pieces of supporter information thus extracted (step S203). After that, the determination portion 13 of the processing portion 11 determines whether or not there is an acceptance from the supporter to whom the signal indicative of the support request is transmitted (that is, whether or not there is an input indicative of an acceptance via the terminal device 30) (step S204).

In the process of step S204, in a case where the determination portion 13 determines that there is no acceptance from the supporter (step S204: No), the determination portion 13 determines whether or not there are pieces of supporter information (that is, other candidates) on supporters to whom the signal indicative of the support request is not transmitted from among the one or more pieces of supporter information extracted in the process of step S202 (step S205).

In the process of step S205, in a case where the determination portion 13 determines that there are pieces of supporter information on supporters to whom the signal indicative of the support request is not transmitted (step S205: Yes), the processing portion 11 transmits the signal indicative of the support request to the terminal device 30 of a supporter specified by supporter information most suitable for the acquired support condition (step S206) from among the pieces of supporter information on the supporters to whom the signal indicative of the support request is not transmitted (step S203).

In the process of step S205, in a case where the determination portion 13 determines that there are not pieces of supporter information on supporters to whom the signal indicative of the support request is not transmitted (step S205: No), the operation illustrated in FIG. 4 is ended. At this time, the processing portion 11 may transmit, to the terminal device 20 of the user via the communication portion 16, a signal indicating that no supporter can be introduced, for example. Further, in a case where there is still time to the date and time requested by the user for support, the date and time being indicated by the support request information, the processing portion 11 may transmit, to the terminal device 20 of the user via the communication portion 16, a signal indicating that a supporter will be introduced by the date and time requested by the user for support, for example.

In the process of step S204, in a case where the determination portion 13 determines that there is an acceptance from the supporter (step S204: Yes), the decision portion 14 of the processing portion 11 decides the supporter (step S207). At this time, the decision portion 14 stores, in the matching information 140, supporter information on the decided supporter, and information on the user who requires support (that is, reservation information, user information, and support request information) in association with each other. Further, the decision portion 14 may delete the supporter information on the decided supporter from the supporter DB 130.

The processing portion 11 transmits (step S208), to the terminal device 20 via the communication portion 16, information for the person requiring support to specify the supporter from the supporter information on the supporter decided in the process of step S207. Further, the processing portion 11 transmits, to the terminal device 30 via the communication portion 16, information for the supporter to specify the person requiring support from the user information on the user corresponding to the person requiring support.

Note that, in a case where there is no input from the supporter for a predetermined time in the process of step S204, the determination portion 13 of the processing portion 11 may consider that there is no acceptance from the supporter and may perform the process of step S205.

Technical Effects

With the support system 1 according to the second embodiment, it is possible to introduce a supporter to a handicapped person who requires support.

Aspects of the disclosure that are derived from the embodiments described above will be described below.

A supporter introduction method according to one aspect of the disclosure includes: an acquisition step of acquiring user information on a user using a vehicle; a determination step of determining whether the user is a handicapped person or not, based on the user information; a specifying step of, in a case where the user is determined to be a handicapped person, specifying a position and a time desired by the user for support based on the user information; and a matching step of matching the user with a supporter who supports the user, based on the position and the time desired by the user for support. The vehicle may be an autonomous driving vehicle.

In the supporter introduction method, the user information may include at least either a getting-on position and a getting-on time for the user to get on the vehicle or a getting-off position and a getting-off time for the user to get off the vehicle, and the position and the time desired by the user for support may be the at least either the getting-on position and the getting-on time or the getting-off position and the getting-off time.

The supporter introduction method may include a transmission step of transmitting, to the supporter, user specification information to specify the user.

The present disclosure is not limited to the embodiments described above. The present disclosure is modifiable appropriately as far as the modification is not against the gist or idea of the disclosure that can be read from claims and the whole specification. A supporter introduction method based on such a modification is also within the technical scope of the present disclosure.

What is claimed is:

1. A supporter introduction method comprising:
an acquisition step of acquiring user information on a user using a vehicle;
a determination step of determining whether the user is a handicapped person or not, based on the user information;
a specifying step of, in a case where the user is determined to be a handicapped person, specifying a position and a time desired by the user for support based on the user information; and
a matching step of matching the user with a supporter who supports the user, based on the position and the time desired by the user for support.

2. The supporter introduction method according to claim 1, wherein:
the user information includes at least either a getting-on position and a getting-on time for the user to get on the vehicle or a getting-off position and a getting-off time for the user to get off the vehicle; and
the position and the time desired by the user for support is the at least either the getting-on position and the getting-on time or the getting-off position and the getting-off time.

3. The supporter introduction method according to claim 1, comprising a transmission step of transmitting, to the supporter, user specification information to specify the user.
